(19) United States
(12) Patent Application Publication
(10) Pub. No.: US 2013/0213588 A1
(43) Pub. Date: Aug. 22, 2013

(54) PARTITIONING DEVICE

(71) Applicant: Tieh-Han WU, Tainan City (TW)

(72) Inventor: Tieh-Han WU, Tainan City (TW)

(21) Appl. No.: 13/773,787

(22) Filed: Feb. 22, 2013

(30) Foreign Application Priority Data
Feb. 22, 2012 (TW) 101105807

(51) Int. Cl. B60N 2/44; E06B 9/24

(52) U.S. Cl. CPC B60N 2/441; E06B 9/24
USPC 160/84.04; 160/368.1; 160/369; 160/87

(57) ABSTRACT

A partitioning device includes at least two mounting units, a transparent and air impermeable main curtain, and a positioning unit. Each mounting unit includes a hanger and a connection member connected to the hanger. The connection member includes a connection body and at least one magnet mounted on one end of the connection body. The main curtain has a first face facing the mounting units and a second face opposite to the first face. The positioning unit is detachably disposed on the second face of the main curtain and includes at least one positioning member that contains metal attractable by the magnet and that cooperates with the magnet to clamp the main curtain.

### CROSS-REFERENCE TO RELATED APPLICATION

This application claims priority of Taiwanese Application No. 101105807, filed on Feb. 22, 2012, the disclosure of which is incorporated herein by reference.

### BACKGROUND OF THE INVENTION

1. Field of the Invention

The invention relates to a partitioning device for a vehicle having an interior space, and more particularly to a partitioning device adapted to divide the interior space of the vehicle into front and back seat regions.

2. Description of the Related Art

Generally, an interior space of a vehicle is maintained at a comfortable temperature by means of a vehicle air conditioner that blows cold air all over the interior space. When all seats in the interior space are not occupied, the portion of the interior space having the unoccupied seats is still filled with the blown cold air, which results in a waste of power consumption. Therefore, there is a need to separate the interior space of the vehicle into different portions based on the necessity for the blown cold air and to control the operation of the vehicle air conditioner to blow cold air to the required portions of the interior space. Thus, the energy efficiency of the vehicle air conditioner may be enhanced and the power consumption may be reduced.

### SUMMARY OF THE INVENTION

Therefore, an object of the present invention is to provide a partitioning device that can substantially divide an interior space of a vehicle, such as an automobile, into front and back seat regions so as to increase the energy efficiency of a vehicle air conditioner and to reduce the energy consumption. According to the present invention, a partitioning device includes at least two mounting units, a transparent and air impermeable main curtain, and a positioning unit.

Each of the mounting units includes a hanger and a connection member connected to the hanger. The connection member includes a connection body and at least one magnet mounted on one end of the connection body.

The main curtain is detachably disposed behind the mounting units, and has a first face facing the mounting units and a second face opposite to the first face.

The positioning unit is detachably disposed on the second face and includes at least one positioning member that contains metal attractable by the magnet and that cooperates with the magnet to clamp therebetween the main curtain.

### BRIEF DESCRIPTION OF THE DRAWINGS

Other features and advantages of the present invention will become apparent in the following detailed description of the preferred embodiments with reference to the accompanying drawings, of which:

FIG. 1 is a partly exploded perspective view to illustrate assembling of the first preferred embodiment of a partitioning device according to the present invention to front seats of a vehicle;

FIG. 2 is a perspective view to illustrate an inner space of the vehicle disposed with an assembled structure of the partitioning device of the first preferred embodiment of FIG. 1 and the front seats;

FIG. 3 is a perspective view to illustrate a hanger of the partitioning device of the first preferred embodiment;

FIG. 4 is a side view to illustrate the assembled structure of the partitioning device of the first preferred embodiment of FIG. 1 and the front seat;

FIG. 5 is a top view of the first preferred embodiment to illustrate the assembled structure of the partitioning device of the first preferred embodiment of FIG. 1 and the front seat;

FIG. 6 is a side view similar to FIG. 4 to illustrate a pivot movement of a main curtain of the partitioning device of the first preferred embodiment relative to the front seat;

FIG. 7 is a partly exploded perspective view to illustrate assembling of the second preferred embodiment of a partitioning device according to the present invention to front seats of a vehicle;

FIG. 8 is a rear view to illustrate the assembled structure of the partitioning device of the second preferred embodiment and the front seats; and

FIG. 9 is a rear view to illustrate the assembled structure of the partitioning device of the third preferred embodiment and the front seats.

### DETAILED DESCRIPTION OF THE PREFERRED EMBODIMENTS

Before this invention is described in detail, it should be noted that, in the following description, similar elements are designated by the same reference numerals.

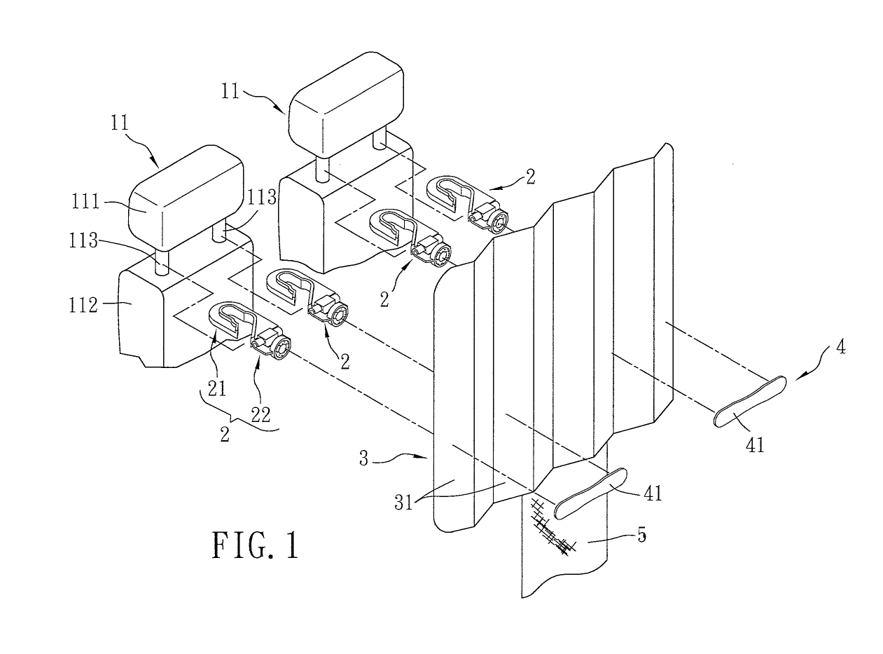

FIGS. 1 to 4 illustrate the first preferred embodiment of a partitioning device of the present invention that is detachably installed in an interior space of a vehicle, such as an automobile. The vehicle includes two front seats 11 and a back seat 12. Each of the front seats 11 includes a headrest portion 111, a seat portion 112 and two connection rods 113 that interconnect the headrest portion 111 and the seat portion 112. The partitioning device includes at least two mounting units 2, a transparent and air impermeable main curtain 3, and a positioning unit 4. In this embodiment, the partitioning device includes four mounting units 2 arranged in a row.

Each of the mounting units 2 is connected to a corresponding one of the connection rods 113 of the front seats 11 and includes a hanger 21 and a connection member 22 connected to the hanger 21. In this embodiment, the hanger 21 includes a hook portion 211 that is hooked at the corresponding connection rod 113, and a pivot pin portion 212 that is connected to the hook portion 211. The connection member 22 of each of the mounting units 2 includes a connection body 221 and a magnet 222 mounted on a rear end of the connection body 221. The connection body 221 of the connection member 22 of each of the mounting units 2 includes two pin-receiving members 223 that are sleeved pivotally around the pivot pin portion 212. Each of the pin-receiving members 223 may be made of a plastic material and may be snuggly sleeved around the pivot pin portion 212. By virtue of a fitted design between the pin-receiving members 223 and the pivot portion 212, the connection member 22 is pivotable relative to the hanger 21.

The transparent and air impermeable main curtain 3 is detachably disposed behind the mounting units 2. The main curtain 3 may be made from a plastic material selected from the group consisting of polyvinyl chloride (PVC), polyurethane (PU), and the combination thereof but should not be limited thereto. The main curtain 3 has a first face 32 that faces toward the mounting units 2, and a second face 33 that is opposite to the first face 32. In this embodiment, the main curtain 3 includes a plurality of flaps 31 that are foldably connected to each other and that cooperatively define the first and second faces 32, 33, so that a width of the main curtain 3 is adjustable and so that the main curtain 3 may be folded or extended.

The positioning unit 4 is detachably disposed on the second face 33 of the main curtain 3, and includes at least one positioning member 41. In this embodiment, the positioning unit 4 includes two positioning members 41 that respectively correspond to two of the mounting units 2. Each of the positioning members 41 contains metal, such as iron, cobalt, nickel, etc., and may be configured as an elongate metal plate. Each of the positioning members 41 is attractable by the magnets 222 of the connection members 22 of the corresponding ones of the mounting units 2 and that cooperates with the corresponding magnets 222 to clamp therebetween the main curtain 3.

Preferably, in this embodiment, the partitioning device further includes an auxiliary curtain 5 that is also air impermeable, that is made of a fabric material, and that is connected a bottom side of the main curtain 3 so as to be suspended downwardly. The auxiliary curtain 5 is preferred to be transparent, and is disposed so as not to block the driver's rear view. In this embodiment, the auxiliary curtain 5 has a width smaller than that of the main curtain 3 and larger than a distance between the two front seats 11 so as to block the cold air from reaching the back seat 12.

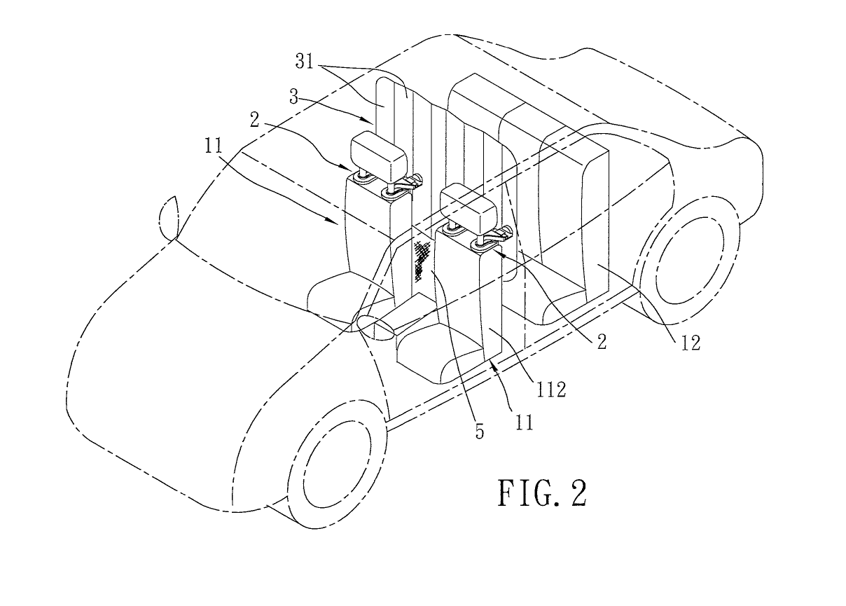

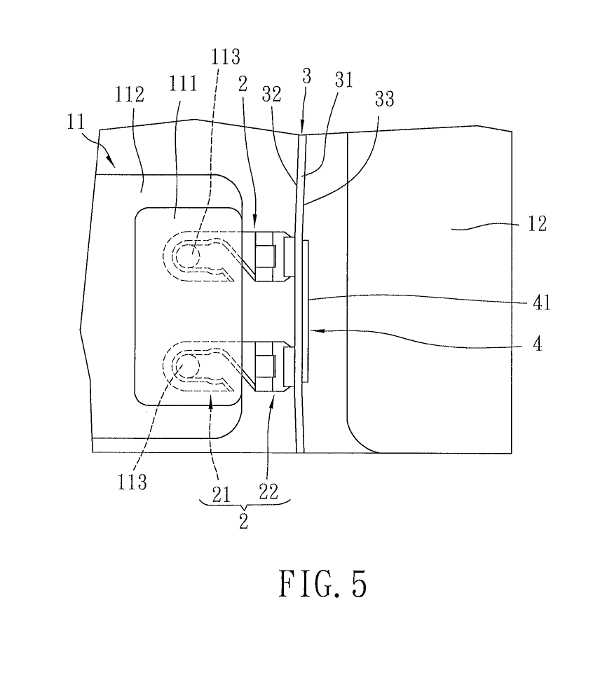

Referring to FIGS. 2 to 5, to use the partitioning device, firstly, the hangers 21 of the mounting units 2 are respectively hooked at the connection rods 113 of the front seats 11 in such a manner that the connection members 22 of the mounting units 2 face toward the rear seat 12. Then, the main curtain 3 is extended and disposed together with the auxiliary curtain 5 connected thereto behind the connection members 22. Thereafter, each of the positioning members 41 of the positioning unit 4 respectively corresponds to the connection members 22 of the corresponding mounting units 2 on the second face 33 of the main curtain 3 and is attracted by and cooperates with the magnets 222 of the corresponding connection members 22 to clamp therebetween the main curtain 3. The main curtain 3 is constrictively positioned between the mounting units 2 and the positioning members 41.

When the back seat 12 is not occupied, the partitioning device may be installed between the front and back seats 11, 12. The main curtain 3 and the auxiliary curtain 5 can block the cool air from reaching the space of the back seat 12 so that the power consumption of the vehicle air conditioner is only required to maintain the space of the front seats 11 at an intended temperature. Hence, the vehicle air conditioner can be operated in a relatively economic and energy-saving way.

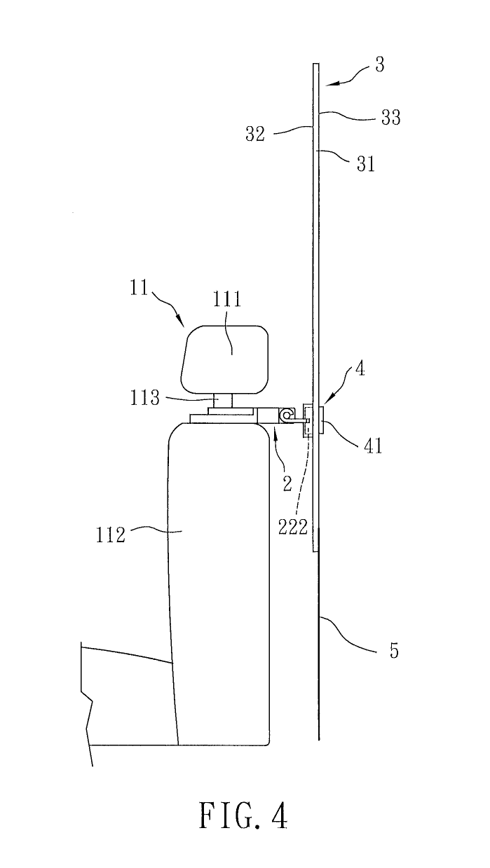

With reference to FIG. 4, in this embodiment, the main curtain 3 mainly extends from a ceiling of the vehicle and approaches upper ends of the seat portions 112. The auxiliary curtain 5 extends from the bottom side of the main curtain 3 and blocks a channel defined by the distance between the front seats 11 so as to divide the interior space of the vehicle into the front and back seat sub-spaces which are not in communication with each other. Alternatively, the auxiliary curtain 5 can be omitted by lengthening the main curtain 3 to block the channel between the front seats 11.

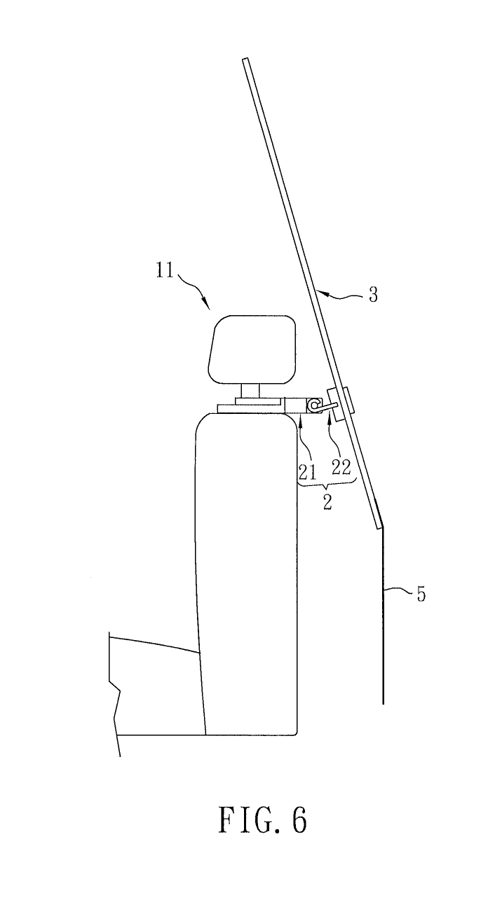

Specifically, since the main curtain 3 is transparent, the partitioning device does not block the driver's rear view. Because the flaps 31 of the main curtain 3 are designed to foldably connect to each other, the width of the main curtain 3 is adjustable to comply with various vehicle interior spaces. In addition, since the auxiliary curtain 5 may be folded over the main curtain 3 and since the flaps 31 of the main curtain 3 are able to overlap each other, the main curtain 3 and the auxiliary curtain 5 facilitate storage and occupy a relatively small storage space. Further referring to FIG. 6, since the connection member 22 of each of the mounting units 2 is designed to be pivotable relative to the hanger 21, an angle of the main curtain 3 relative to the front seats 11 is adjustable to comply with various models of vehicles.

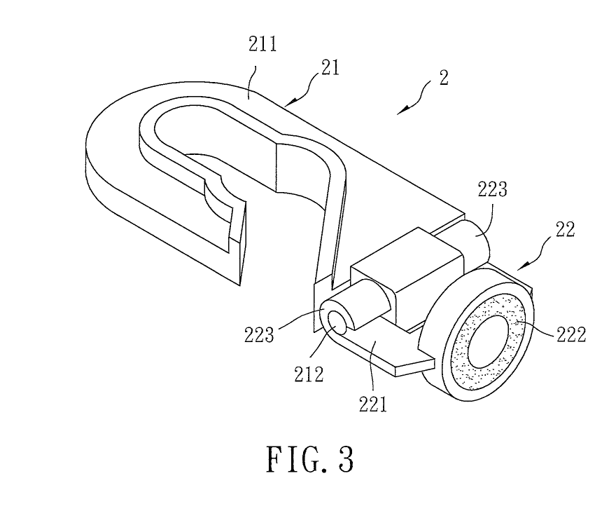

With reference to FIGS. 1 and 3, components of the partitioning device, i.e., the mounting units 2, the main curtain 3 and the positioning unit 4, are detachably connected to each other. Besides, the hangers 21 of the mounting units 2 are detachably connected to the connection rods 113 of the front seats 11. When not in use, the partitioning device is easily detached from the front seats 11.

Although four mounting units 2 arranged in a row are exemplified in this preferred embodiment, the present invention is not limited in this respect. For example, the partitioning device of the present invention may have only two mounting units 2 that are respectively disposed behind the two front seats 11, as long as the magnets 222 have a strong magnetic force sufficient for attracting the positioning members 41 of the positioning units 4 to clamp the main curtain 3 therebetween. Similarly, the number of the positioning units 4 may be varied according to the actual application.

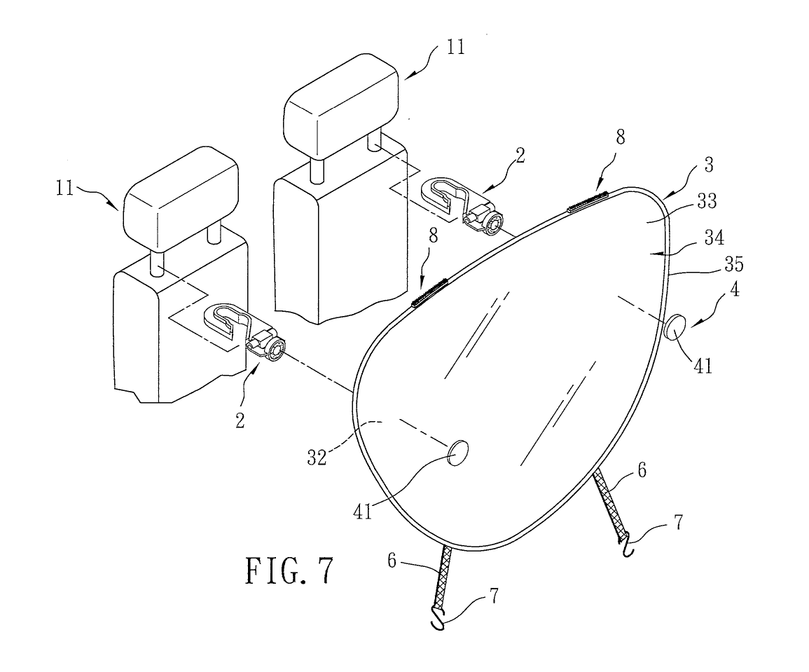

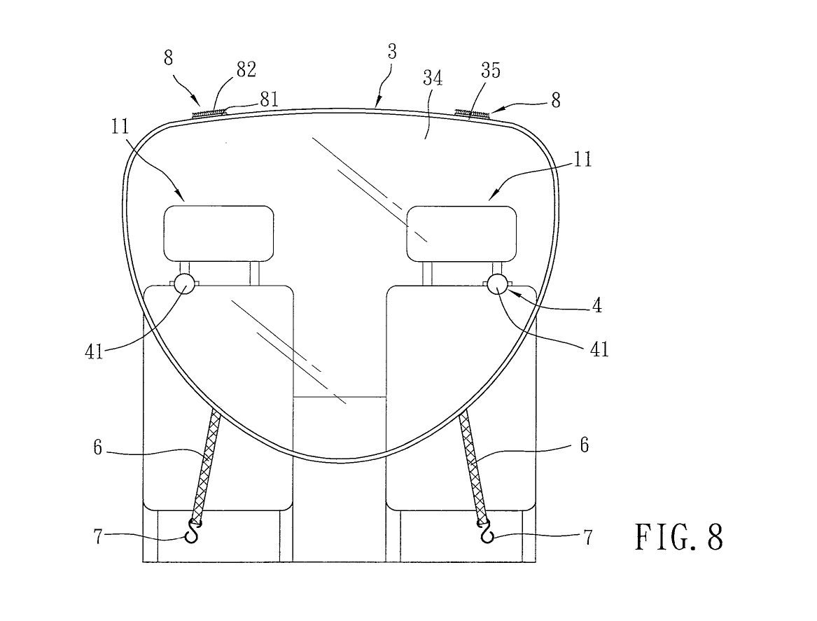

FIGS. 7 and 8 show a second preferred embodiment of a partitioning device according to this invention, which has a structure generally similar to that of the first preferred embodiment. In this embodiment, the partitioning device includes two spaced-apart mounting units 2 respectively disposed on the front seats 11 in a row. The positioning unit 4 has two positioning members 41 that are spaced apart from each other and that respectively correspond to the two mounting units 2. Each positioning member 41 is configured as a circular shape, but should not be limited thereto.

In this embodiment, the transparent and air imermeable main curtain 3 includes a curtain sheet 34 that has the first face 32 and the second face 33, and an outer flexible frame 35 that surrounds and is connected to the curtain sheet 34. The outer flexible frame 35 may be made from a plastic material or a metallic material and may be designed to be deformable and restorable. During storage of the main curtain 3, the outer flexible frame 35 is firstly twisted and then the curtain sheet 34 is folded so that the main curtain 3 is readily reduced to a relatively small size for storage.

Preferably, the partitioning device further includes two spaced-apart elastic strings 6 connected to a bottom of the main curtain 3 at one end, two hooks 7 that are respectively connected to other ends of the strings 6, and two spaced-apart hook-and-loop fasteners 8 that are disposed on top of the main curtain 3. In this embodiment, the strings 6 are connected to a bottom of the outer flexible frame 35 that surrounds the bottom of the main curtain 3, and the other ends of the strings 6 disposed with the hooks 7 are distal from the bottom of the outer flexible frame 35. Each of the hook-and-loop fasteners 8 has a fixture surface 81 that is fixed on top of the outer flexible frame 35, and a fleece surface 82 that is opposite to the fixture surface 81. The fleece surfaces 82 may be attachably engaged with one of the ceiling and an inner lateral side of the vehicle, thereby facilitating securing of the main curtain 3. The number of the hook-and-loop fasteners 8 is not limited and may vary from one to two or more.

In this embodiment, the mounting units 2 and the positioning unit 4 cooperatively secure the main curtain 3 behind the front seats 11. The top of the outer flexible frame 35 is able to abut against the ceiling of the vehicle and is supportive to secure the main curtain 3. Securing of the main curtain 3 can be enhanced by means of the engagement between the hook-and-loop fasteners 8 and one of the ceiling and the inner lateral side of the vehicle. The elastic strings 6 are stretchable such that the hooks 7 are able to be hooked to any appropriate portion in the interior space of the vehicle, such as base portions of the front seats 11 to facilitate securing of the main curtain 3.

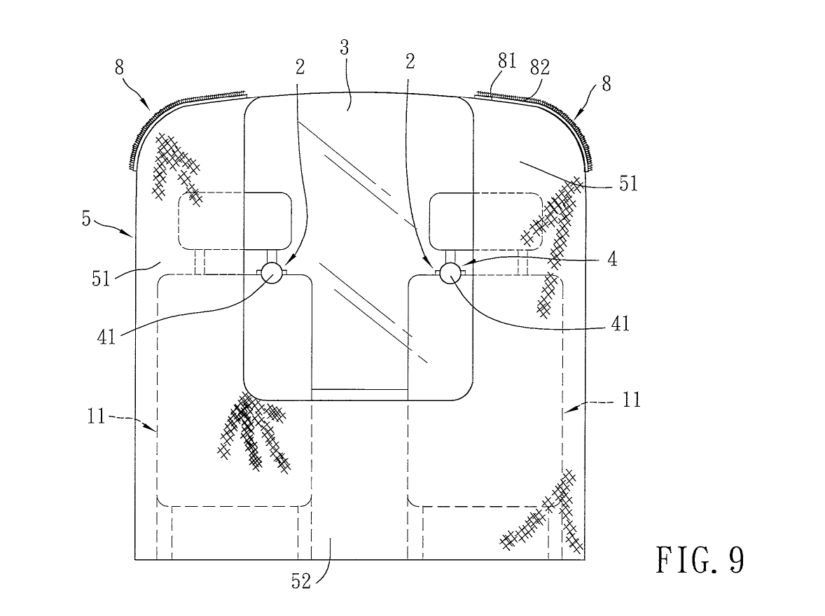

FIG. 9 shows a third preferred embodiment of a partitioning device according to the present invention, which has a structure generally similar to that of the first preferred embodiment. In this embodiment, the partitioning device includes two spaced-apart mounting units 2 that are respectively disposed on the front seats 11 in a row. The positioning unit 4 includes two positioning members 41 that are spaced apart from each other, and that correspond respectively to the mounting units 2. The auxiliary curtain 5 is peripherally connected to the main curtain 3, such as by sewing, so that the combination of the auxiliary curtain 5 and the main curtain 3 has a size sufficient to divide the interior space of the vehicle into the front and back sub-spaces and so that the main curtain 3 has a relatively small size sufficient for blocking the channel defined by the distance between the two front seats 11.

In this embodiment, the auxiliary curtain 5 includes two lateral regions 51 that are respectively connected to two opposite sides of the main curtain 3, and a bottom region 52 that is connected to the bottom side of the main curtain 3. The auxiliary curtain 5 may be made of an air impermeable material. Since the driver's rear view is obtained by seeing through the main curtain 3 and is not blocked by the auxiliary curtain 5, the auxiliary curtain 5 is not required to be transparent.

Preferably, the auxiliary curtain 5 further includes two hook-and-loop fasteners 8 that are respectively disposed on top edges of the lateral regions 51. Each of the hook-and-loop fasteners 8 has a fixture surface 81 fixed on a corresponding one of the lateral regions 51, and a fleece surface 82 that is opposite to the fixture surface 81. The fleece surfaces 82 may be engaged with one of the ceiling and the inner lateral side of the vehicle, so that the auxiliary curtain 5 may be extended and secured in the vehicle.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A partitioning device, comprising:
at least two mounting units, each of said mounting units including a hanger and a connection member connected to said hanger, said connection member including a connection body and at least one magnet mounted on one end of said connection body;
a transparent and air impermeable main curtain detachably disposed behind said mounting units, said main curtain having a first face facing said mounting units and a second face opposite to said first face; and
a positioning unit detachably disposed on said second face, said positioning unit including at least one positioning member that contains metal attractable by said magnet and that cooperates with said magnet to clamp therebetween said main curtain.

2. The partitioning device as claimed in claim 1, further comprising two spaced-apart elastic strings connected to a bottom of said main curtain at one end, and two hooks respectively connected to another ends of said strings.

3. The partitioning device as claimed in claim 1, further comprising at least one hook-and-loop fastener disposed on top of said main curtain.

4. The partitioning device as claimed in claim 1, wherein said main curtain includes a curtain sheet that has said first and second faces and an outer flexible frame that surrounds and is connected to said curtain sheet.

5. The partitioning device as claimed in claim 1, wherein said hanger of each of said mounting units includes a hook portion and a pivot pin portion that is connected to said hook portion, said connection body of said connection member including at least one pin-receiving member that is sleeved pivotally around said pivot pin portion.

6. The partitioning device as claimed in claim 1, wherein said main curtain includes a plurality of flaps foldably connected to each other, said flaps cooperatively defining said first and second faces.

7. The partitioning device as claimed in claim 1, comprising four of said mounting units arranged in a row.

8. The partitioning device as claimed in claim 1, further comprising an auxiliary curtain that is air impermeable, that is made of a fabric material, and that is connected to a bottom side of said main curtain so as to be suspended downwardly.

9. The partitioning device as claimed in claim 8, wherein said auxiliary curtain includes two lateral regions respectively connected to two opposite sides of said main curtain, and a bottom region connected to said bottom side of said main curtain.

10. The partitioning device as claimed in claim 9, wherein said auxiliary curtain further includes two hook-and-loop fasteners respectively disposed on top of said lateral regions, each of said hook-and-loop fasteners having a fixture surface fixed on a corresponding one of said lateral regions, and a fleece surface opposite to said fixture surface.
